(19) United States
(12) Patent Application Publication
(10) Pub. No.: US 2010/0129503 A1
(43) Pub. Date: May 27, 2010

(54) PACKAGES FOR STEAM VENTING, AND METHODS

(76) Inventor: Robert Chadwick Flaherty, Loves Park, IL (US)

Correspondence Address: Perman & Green, LLP, 99 Hawley Lane, Stratford, CT, 06614, US

(21) Appl. No.: 12/596,389

(22) PCT Filed: Apr. 15, 2008
(86) PCT No.: PCT/US08/60302

§ 371 Date: Jan. 27, 2010

Related U.S. Application Data
(60) Provisional application No. 60/912,546, filed on Apr. 18, 2007.

(51) Int. Cl. B65D 81/34; B65D 33/01; B65D 30/08; H05B 6/80

(52) U.S. Cl. 426/234; 383/103; 383/109; 219/725; 426/395

(57) ABSTRACT

A “freezer to microwave oven” package (10) which can be heated in a microwave without consumer intervention. The package includes at least one venting arrangement present in a seal, the venting arrangement including a water compatible coating (28) that provides a vent from the interior of the package to the exterior, upon exposure of the coating to a fluid water source. The fluid water source (e.g., liquid water or vapor) solubilizes, dissolves or otherwise renders ineffective the coating, forming a fluid path from interior of the package to the exterior of package, thus allowing escape of pressure from the package.

This application is being filed on 15 Apr. 2008 as a PCT International Patent application in the name of Kapak Corporation, a U.S. national corporation, applicant for the designation of all countries except the US, and Robert Chadwick Flaherty, a citizen of the U.S., applicant for the designation of the US only, and claims priority to U.S. Provisional Patent Application No. 60/912,546, filed Apr. 18, 2007.

### TECHNICAL FIELD

This disclosure generally relates to flexible polymeric packages having a venting arrangement to allow the release of pressure, such as upon heating.

### BACKGROUND

A variety of items are marketed and enclosed within flexible bags, pouches, or package constructions. Examples include non-edible items, as well as edible items such as pet food, coffee, cookies, rice, salt, candies, etc. Many of these packages can be stored at room temperature. However, some items, such as vegetables, are best when stored chilled, e.g., frozen.

With today's fast-paced society, many end-users prefer items (e.g., foods,) that are quick and convenient to prepare. The microwave is now a mainstay in the American household for food preparation. The consumer desires food packaging that can be taken from the chilled environment, e.g., freezer, and that can be readily heated, e.g., microwave heated.

What is desired is a package that can be taken from a first temperature, such as a freezer, and then exposed to an elevated temperature, such as such resulting from heating in a microwave. Various constructions have been known for this application. Often, these packages include user interaction to provide a vent in the package to provide an escape for the increasing pressure. There is always room for improvements specifically eliminating the need for the end-user to interact with the package.

### SUMMARY OF THE DISCLOSURE

The present disclosure is directed to generally flexible, polymeric packages that have a body and at least one venting arrangement present in a seal. The venting arrangement includes a water compatible coating that provides a vent from the interior of the package to the exterior, upon exposure of the coating to a fluid water source. The fluid water source (e.g., liquid water or vapor) solubilizes, dissolves or otherwise renders ineffective the coating, forming a fluid path from the interior of the package to the exterior of the package, thus allowing the escape of pressure from the package. The present disclosure is also directed to the roll stock used to make such packages.

In one particular aspect, this disclosure is directed to a flexible package having a flexible body having at least one seal and a venting arrangement extending through the at least one seal from the package interior, the venting arrangement comprising a water compatible coating. The at least one seal may be formed between a first portion of the body and a second portion of the body, so that the venting arrangement extends therebetween, or the at least one seal may be formed between a first panel and a second panel, so that the venting arrangement extends between those panels.

The body or panels of the package may be, for example, polyester, polyamide (nylon), polyethylene, polypropylene, copolymer or polymer blend, i.e., ethylene vinyl acetate (EVA), ethylene acrylic acid (EAA), or ethylene normal butyl acetate (EnBA). The material that forms the body or panels may include a coating or treatment to facilitate the formation of the resulting package.

The coating may include a starch, gum, sugars, or water soluble proteins, or other food grade coating, and may be present only in the seal area or may be present on the entire package interior, or portions thereof.

In another particular aspect, this disclosure is directed to a self-venting flexible package that has a first polymeric panel and a second polymeric panel, the first and second panels being sealed together to form an interior with an item therein. A venting arrangement comprising a water compatible coating extends from the interior between the first panel and the second panel, wherein the venting arrangement breaks when exposed to liquid or vapor water to release pressure from the interior of the package. The venting arrangement may break to release pressure, e.g., steam pressure.

The packages of this disclosure are particularly suited for storing and heating of food items therein, without the need for end-user intervention.

This disclosure is also directed to methods of using the packages, such as to heat items (e.g., food items). One particular method includes providing a self-venting package comprising a flexible body having at least one seal, the body defining a package interior with a food item therein, and a venting arrangement extending through the at least one seal from the interior, the venting arrangement comprising water compatible coating, heating the package to raise the temperature of the food item, such as creating steam under pressure on the interior of the package; and breaking the venting arrangement to release the pressure. The package is particularly adapted for heating in a microwave oven.

The package may be referred to as a “freezer to microwave” oven package.

### BRIEF DESCRIPTION OF THE DRAWINGS

FIG. 1 a schematic perspective view of a package according to this disclosure;

FIG. 1A is a cross-sectional view of the package of FIG. 1 taken along line A-A;

FIG. 2 is a schematic plan view of film stock used for making the package of FIG. 1;

FIG. 3 is a schematic plan view of the film stock of FIG. 2, prior to incorporation into the package of FIG. 1;

FIG. 4 is a schematic plan view of the package of FIG. 1 venting pressure from its interior; and

FIG. 5 is schematic perspective view of a second embodiment of a package according to this disclosure.

### DETAILED DESCRIPTION

The packages of this disclosure include a venting arrangement in a seal area where two polymeric film portions join. The venting arrangement includes a water compatible coating, which can be an adhesive coating, that provides a vent from the interior of the package to the exterior, upon exposure of the coating to a fluid water source.

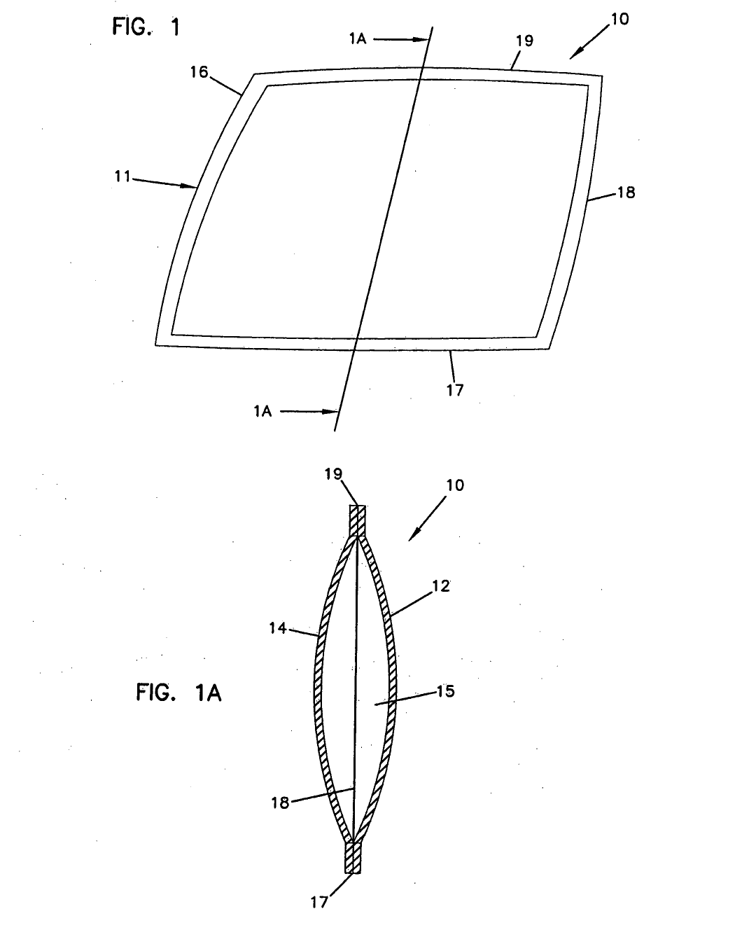

Referring to the figures, a flexible package is illustrated in FIGS. 1 and 1A. Package 10 includes a body 11 defined by a first panel 12 and an opposite second panel 14 that are connected by side edges 16, 17, 18, 19. For clarity herein, in this orientation of package 10, side edge 17 can be referred to as a bottom edge 17 and side edge 19 can be referred to as a top edge 19.

Side panels 12, 14 and side edges 16, 17, 18, 19 define body 11 with a storage interior 15 therebetween. Various other configurations of body 11 are known and are suitable for packages in accordance with the principles of this disclosure. Storage interior 15 is configured for receiving an item, such as a foodstuff item or other item(s), for storage within package 10.

In this embodiment, package 10 is a rectangular package, having four side edges. It is understood that other shaped packages are within the scope of this disclosure, e.g., triangular packages with three side edges, circular packages with one edge or tube-shaped packages with either a fin or lap seal as would be produced on a vertical or horizontal form fill and seal machine.

Side panels 12, 14 are flexible sheets, typically polymeric film. Examples of suitable films for use as panels 12, 14 are well known, and include polyester, polyamide (nylon), polyethylene (e.g., LDPE, HDPE), polypropylene, copolymer or polymer blends (e.g., ethylene vinyl acetate (EVA), ethylene acrylic acid (EAA), or ethylene normal butyl acetate (EnBA)) and the like. Multi-layered, e.g. co-extruded film or laminated materials may also be used. A laminated material can be any two or more dissimilar materials joined with an adhesive or extrusion laminated (e.g., biaxially oriented polyester or biaxially oriented polyamide joined to a polyethylene or polypropylene).

As provided above, side panels 12, 14 meet at bottom edge 17, side edges 16, 18 and at top edge 19. Any or all of edges 16, 17, 18, 19 may be seals or may be folds. In package 10 of FIGS. 1 and 1A, each of edges 16, 17, 18 and 19 is a seal. In alternate embodiments, for example, one of side edges 16, 18 could be a fold and the other of side edges 16, 18 could be a seal. For example, one piece of film material could be folded to form panels 12, 14, thus forming one folded side edge (e.g., side edge 16) and one sealed side edge (e.g., side edge 18). Top and bottom edges 17, 19 would also be seals. In an alternate configuration, a tube of material can be used, thus forming two folded side edges (side edges 16, 18). These various edge configurations are known in the art and any of these are suitable for package 10.

Seals at edges 16, 17, 18, 19 may be adhesive seals or may be heat-welded seals, formed by the melting of panels 12, 14 together.

In accordance with this disclosure, at least one of side edges 16, 17, 18 and 19 includes a venting arrangement (not visible in this figure), which, upon activation, provides fluid communication from interior 15 of package 10 to the exterior of package 10.

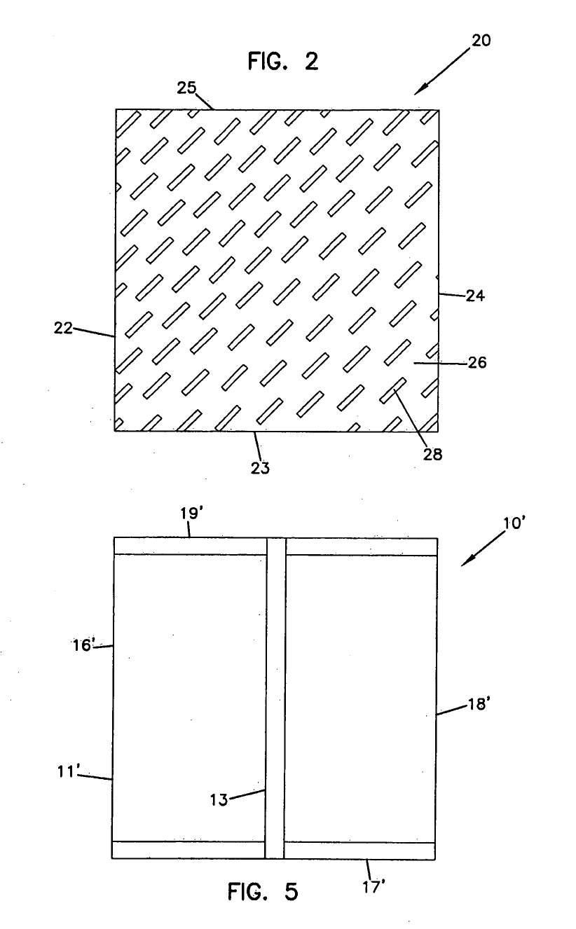

Referring to FIG. 2, a polymeric sheet suitable for body 11, specifically suitable for either or both side panels 12, 14, is illustrated. Sheet 20 includes edges 22, 23, 24, 25, which define the shape and size of sheet 20. Sheet 20 includes a base sheet 26, and a coating 28 covering a portion of base sheet 26. By the term “coating,” it is meant a material or layer that partially or fully covers, or coats, a surface, and in some situations also acts as an adhesive to provide or promote adhesion.

Coating 28 includes at least one coating that is compatible with water. By the term “compatible with water” or variations thereof, it is meant that the coating may be soluble in water, may be miscible with water, or that water hydrates the coating. The coating is non-toxic, and in preferred embodiments, the coating is edible or food-grade. Preferably, coating 28 is non-toxic, and in preferred embodiments, is edible or food-grade.

A variety of food-grade coatings or tacking agents may be present in coating 28. Food grade starches are suitable for coating 28. Starches, in a pregelatinized or non-pregelatinized form, hydrate in water and have good film-forming properties. Examples of suitable starches include tapioca dextrin K4484 and corn syrup solids (“N-Tack”) from National Starch & Chemical Co. and instant starch B792, cooked starch B790, and maltodextrin M180, all from Grain Processing Corp. of Muscatine, Iowa. Other suitable materials include polysaccharide gums such as gellan gum, xanthan gum, gum arabic, and cellulose gum or mixtures thereof. An example of a cellulose gum is sodium carboxymethyl cellulose. Others include sugars and water soluble proteins.

Coating 28 may consist of the water compatible coating, or may include a binder or additive(s). That is, the “water compatible” coating may be present as 100% of coating 28, or may be only a portion of the material used for coating 28. For example, a material generally not known as a coating may be combined with the water compatible coating to provide coating 28. Any binder or additive(s) may help to help plasticize or modify the surface tension of adhesive coating 28. For example, ethylene acrylic acid (e.g., “MP4983” or “MP4990” ethylene acrylic acid from Michelman) may be combined with a water compatible coating (e.g., starch) to provide a suitable coating 28. Polysorbate and propylene glycol are other examples of suitable additives. The amount of water compatible coating and any binder or additive(s) will depend on the specific coating and binders or additive(s) used.

Sheet 20 may include a coating (e.g., primer) or treatment thereon to facilitate forming of the desired package. For example, the surface energy of sheet 20 may be modified (e.g., by corona treating) to facilitate wetting of coating 28.

Returning to FIG. 2, coating 28 is not continuous, but configured so that portions of base sheet 26 remain exposed. In many embodiments, at least 25% of base sheet 26 remains exposed in the coated portion; that is, coating 28 occupies no more than 75% of base sheet 26 in the coated portion. In other embodiments, at least 75% of base sheet 26 in the coating portion remains exposed, so that coating 28 occupies no more than 25%. Other amounts of coverage, either in between, more coverage or less coverage, are acceptable in other embodiments.

In this illustrated embodiment, coating 28 is a series of parallel, discontinuous lines over the expanse of base sheet 26. Other patterns for coating 28 may be used, such as patterns of lines (including continuous lines, wavy lines, intersecting lines), patterns of shapes (including polymeric shapes with filled centers or not, and random shapes), and combinations and variations thereof. Coating 28 is configured so that upon incorporation into package 10, coating 28 extends through a side seal area, as described below.

Coating 28 is present in at least one of the areas that forms sealed side edge 16, 17, 18, 19 of package 10. In FIG. 2, coating 28 is present in all of the areas that form side edges 16, 17, 18, 19 and, in addition, present in areas of base sheet 26 that form panels 12, 14; in this embodiment, the entire surface of sheet 20 has coating thereon. In another embodiment, coating 28 may be present in only select areas of base sheet 26, e.g., those that form one or more of side edges 16, 17, 18, 19. In these embodiments, coating 28 will be in register with the eventual size and shape of package 10. In these areas where coating 28 is present, it may occupy no more than 75% of these areas.

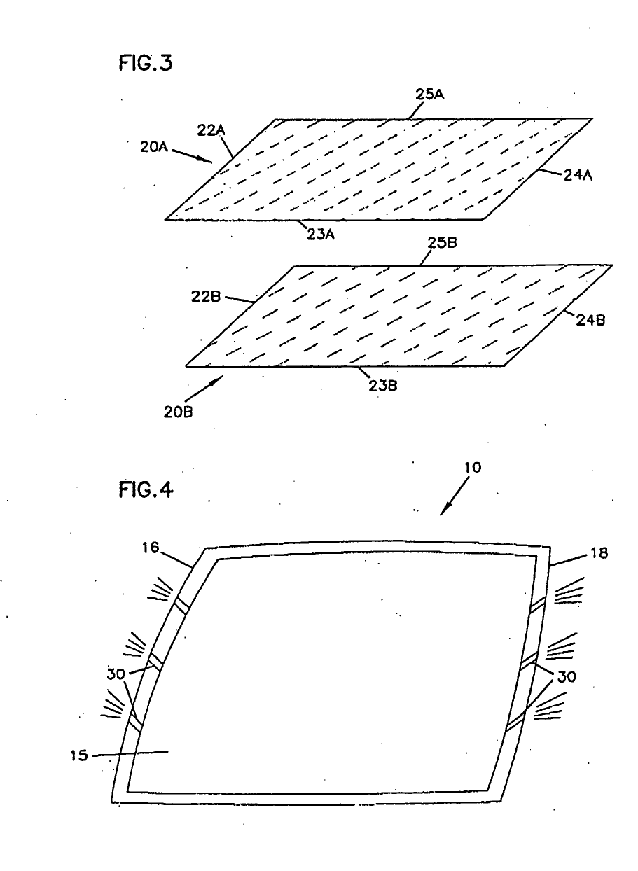

FIG. 3 illustrates two sheets 20, sheets 20A, 20B, each similar to sheet 20 of FIG. 2, positioned in preparation to form package 10. Side edges 22A, 23A, 24A, 25A align with and overlap side edges 22B, 23B, 24B, 25B, respectively. In this resulting package, i.e., package 10 of FIG. 1, each of side edges 16, 17, 18, 19 will include seals made at side edges 22A/B, 23A/B, 24A/B, 25A/B. Coating 28 is of sufficient shape and size so that coating 28 extends through the seal at least one of side edges 16, 17, 18, 19. Although not necessary, coating 28 of sheet 20A intersects with coating 28 of sheet 20B where sealed. In some embodiments, a non-water compatible adhesive may be used to facilitate sealing of side edges 22A/B, 23A/B, 24A/B, 25A/B.

Upon forming of seals between sheets 20A, 20B to form side edges 16, 17, 18, 19 of packages 10, interior 15 is defined therebetween, where sheet 20A is not sealed to sheet 20B. Coating 28, on either or both of sheets 20A, 20B, forms a path between interior 15 and the exterior of package 10.

Package 10 is particularly suited for storing of items, such as frozen food items including vegetables, fruit, French fries, and the like, which are typically heated, e.g., in a microwave oven. Package 10 is configured to be “freezer to microwave”, in that package 10, with frozen items within interior 15, can be placed into a microwave oven and the items therein heated. Package 10 includes a venting arrangement that provides fluid communication from interior 15 to the exterior of package 10.

In many embodiments, package 10 will be filled with items at a packaging plant, when the package is made. In some embodiments, package 10 may be filled after the package is made. Generally however, package 10 will be obtained by the consumer already filled with the items.

FIG. 4 illustrates package 10 venting from interior 15 to the exterior of package 10 via a venting arrangement present in side edges 16, 18. Venting arrangement includes vents 30, formed by coating 28. In fact, vents 30 are caused by the lack of coating 28. Vents 30 may be present where coating 28 on panel 12 contacts coating 28 on panel 14, where coating 28 on panel 12 contacts panel 14, or where panel 12 contacts coating 28 on panel 14. Vents 30 are present between panel 12 and panel 14; vents 30 do not form within the interior of either panel 12, 14 (e.g., a laminated panel does not delaminate).

In use, when package 10 is filled with frozen items (e.g., vegetables) interior 15 includes cold air and crystals of ice (frozen water). As the temperature within interior 15 increases, the cold air warms and the ice eventually melts, possibly forming liquid water. Eventually, the temperature of the water within interior, 15 increases sufficiently, forming steam (vaporized water) within interior 15.

As described above, coating 28, a water compatible coating, forms a path between interior 15 and the exterior of package 10. As a coating 28 comes into contact with fluid water (e.g., liquid or vapor water), coating solubilizes, dissolves rendered ineffective as an adhesive by the fluid water, the path from interior 15 to the exterior of package 10 is unhindered, thus forming vents 30. Increased pressure within interior 15, caused by the expanding air and steam, escapes from interior 15 via vents 30.

FIG. 5 illustrates an alternate embodiment of a ventable package according to this disclosure. Package 10′ of FIG. 5 is similar to package 10 of FIGS. 1 and 1A in having a body 11′ defined by a first panel and an opposite second panel that are connected by side edges 16′, 17′, 18′, 19′. In package 10′, side edges 16′, 18′ are folds and side edges 17′, 19′ are seals. Package 10′ includes a central seal 13, which, in this embodiment, includes a venting arrangement.

Package 10′ is made, for example, by folding sheet 20 of FIG. 2 to join edge 22 with edge 24, and sealing together to form central seal 13. Folded edges 23, 25 are sealed to themselves to form edges 17′, 19′, respectively. Coating 28 is of sufficient shape and size so that coating 28 extends through the seal at central seal 13 and optionally at edges 17′, 19′. Coating 28 forms a path between the interior and the exterior of package 10′ through central seal 13. Package 10′, upon presence of fluid water and increased pressure therein, vents in the same manner as package 10.

The above description and the attached drawings provide a description of various embodiments of a ventable, flexible package. It is understood that the various elements and details of the venting arrangement illustrated in the figures and/or discussed above are interchangeable among various package designs, and that variations of the various elements and details are within the scope of this disclosure. Additionally, the various elements and details of the venting arrangement can be used with generally any package having generally any sealing arrangement and/or sealing region configuration. Since many embodiments of the disclosure can be made without departing from the spirit and scope of the invention, the invention resides in the claims hereinafter appended.

What is claimed:

1. A flexible package, comprising
a flexible body having at least one seal, the body defining a package interior; and
a venting arrangement extending through the at least one seal from the interior, the venting arrangement comprising a water compatible coating.

2. The package of claim 1, wherein the at least seal is formed between a first portion of the body and a second portion of the body, and the venting arrangement extends therebetween.

3. The package of claim 2, wherein the flexible body comprises a first polymeric panel and a second polymeric panel, and the at least one seal joins the first polymeric panel with the second polymeric panel.

4. The package of claim 2, wherein the flexible body comprises a first polymeric panel having a first side edge and an opposite second side edge, and the at least one seal joins the first side edge and the second side edge.

5. The package of any one of claims 1-4, wherein the water compatible coating comprises starch.

6. The package of any one of claims 1-4, wherein the water compatible coating comprises sugar or water soluble proteins.

7. The package of any one of claims 1-6, wherein the body comprises polyester, polyethylene or polypropylene.

8. The package of any one of claims 1-7, wherein the water compatible coating is additionally present in the package interior.

9. A self-venting flexible package comprising:
a first polymeric panel;
a second polymeric panel, the first and second panels being sealed together to form an interior with an item therein; and
a venting arrangement comprising a water compatible coating extending from the interior between the first panel and the second panel, wherein the venting arrangement breaks to release pressure from the interior of the package.

10. The package of claim 9, wherein the water compatible coating comprises starch.

11. The package of any one of claims 9 and 10, wherein the water compatible coating is present as a pattern of parallel, spaced lines.

12. The package of any one of claims 9-11, wherein the first polymeric panel and the second polymeric panels comprise polyester, polyethylene or polypropylene.

13. The package of any one of claims 9-12, wherein the venting arrangement breaks to release steam pressure form the interior of the package.

14. A food item that is prepared in a microwave oven, comprising:
a self-venting package comprising:
a flexible body having at least one seal, the body defining a package interior; and
a venting arrangement extending through the at least one seal from the interior, the venting arrangement comprising a water compatible coating; and
a food item present within the package interior.

15. A method of heating a food item in a package, comprising:
providing a self-venting package comprising a flexible body having at least one seal, the body defining a package interior with a food item therein, and a venting arrangement extending through the at least one seal from the interior, the venting arrangement comprising a water compatible coating;
heating the package to raise the temperature of the food item; and
breaking the venting arrangement to release pressure.

16. The method of claim 15, wherein heating the package comprises exposing the package to microwave energy.

17. The method of claim 16, wherein providing a self-venting package comprises providing a self-venting package having a frozen food item therein.

18. A packaging material comprising:
a polymeric web having a surface; and
a discontinuous coating of a water compatible coating on a first portion of the surface.

19. The material of claim 18, wherein the discontinuous coating occupies no more than 75% of the first portion.

20. The material of claim 18, wherein the discontinuous coating is not present on a second portion of the surface.

21. The material of claim 18, wherein the discontinuous coating occupies no more than 75% of the surface.

22. The material of claim 18, wherein the discontinuous coating comprises parallel, spaced lines.
